(19) United States
(12) Patent Application Publication
(10) Pub. No.: US 2006/0143080 A1
(43) Pub. Date: Jun. 29, 2006

(54) Generating and/or serving dynamic promotional offers such as coupons and advertisements

(76) Inventors: Ashutosh Garg, Sunnyvale, CA (US); Allen Romero, San Francisco, CA (US)

Correspondence Address: STRAUB & POKOTYLO, 620 TINTON AVENUE, BLDG. B, 2ND FLOOR, TINTON FALLS, NJ, 07724, US

(21) Appl. No.: 11/025,892

(22) Filed: Dec. 29, 2004

(51) Int. Cl. G06Q 30/00; G06F 17/30; G06F 17/00

(52) U.S. Cl. 705/14; 707/3; 707/104.1

(57) ABSTRACT

A promotional offer may be generated by (i) accepting information concerning at least one of (A) a search query entered, at a client device, by a user, (B) an item or establishment which is the subject of a search result selected by a user using a client device, (C) one or more items or establishments which are elements of a shopping session summary provided to a user via a client device, (ii) determining a promotional offer to serve using at least the accepted search query information, and (iii) determining terms of the promotional offer using at least one of (A) a location of the client device, (B) a distance from the client device to an establishment associated with the promotional offer, and (C) a distance from the client device to an establishment competing with the establishment associated with the promotional offer, (D) an inventory, at an establishment associated with the promotional offer, of the goods which the promotional offer concerns, (E) a capacity, at an establishment associated with the promotional offer, to provide the services which the promotional offer concerns, (F) a level of excess capacity, at an establishment associated with the promotional offer, to provide the services which the promotional offer concerns, (G) a perishability of goods which the promotional offer concerns, and (H) a remaining shelf-life of goods which the promotional offer concerns.

### §1. BACKGROUND OF THE INVENTION

§ 1.1 Field of the Invention

The present invention concerns commerce. In particular the present invention concerns tools for helping shoppers during a visit to a store, shopping mall, transportation terminal, resort, shopping district, etc.

§ 1.2 Background Information

The Internet has enabled rapid growth of online commerce. For example, the Website Amazon.com has provided a way for computer users (referred to simply as “users,” which is intended to include users of other devices such as mobile telephones, personal digital assistants, etc.) to purchase books, and more recently other types of merchandise. In addition to goods-related commerce, the Internet has also enabled services-related commerce. For example, software application providers can download software and updates to customers over the Internet. As another example, compressed, digitized music can be downloaded onto customers' personal music players (e.g., so-called MP3 players).

The Internet has also enabled new ways to research and find products and services. Such research may concern online vendors and service providers (virtual stores), but can also concern traditional vendors and service providers with physical locations. One example of a product research service is Froogle™ from Google™ Corporation of Mountain View, Calif. Froogle™ uses powerful search technologies to allow users to locate stores that sell an item they are interesting in purchasing (or that sell an item belonging to a category of items). As another example, Google Catalogs™ allows users to search through digitized versions of print catalogs. As yet another example, Google Local™ permits users to search for local vendors and service suppliers. The results of such searches may include item price, item availability, etc.

Unfortunately, shoppers at large stores, shopping malls, etc. often have trouble finding products or services that they are looking for, or having their questions about products or services answered. In-store or in-mall customer services representatives can be helpful in this regard provided that they are accessible, knowledgeable, and courteous, and have good communication skills. Unfortunately, vendors must be careful to ensure that their human customer service representatives are neat in appearance, courteous, and knowledgeable. Even if vendors are able to ensure this level of service, providing such service may be expensive, and may often be underutilized or overworked as demand varies. Inadequate customer service can lead to lost sales and disappointed customers.

Although physical maps and directories can be used by shoppers to find what they are looking for, they are difficult to maintain and update, and provide only general information. Although some malls have kiosks with hierarchical menus and scrollable content, many shoppers may find such kiosks archaic in view of powerful and sophisticated search technologies that they may use at home or at work.

In view of the foregoing, it would be useful to provide simple, yet powerful tools to help people to obtain goods and services, particularly, if those people are in a store, a shopping mall, a transportation terminal, a resort, a shopping district, etc.

### § 2. SUMMARY OF THE INVENTION

At least some embodiments consistent with the present invention may generate a promotional offer by (i) accepting information concerning at least one of (A) a search query entered, at a client device, by a user, (B) an item or establishment which is the subject of a search result selected by a user using a client device, and (C) one or more items or establishments which are elements of a shopping session summary provided to a user via a client device, (ii) determining a promotional offer to serve using at least the accepted search query information, and (iii) determining terms of the promotional offer using at least one of (A) a location of the client device, (B) a distance from the client device to an establishment associated with the promotional offer, and (C) a distance from the client device to an establishment competing with the establishment associated with the promotional offer.

At least some embodiments consistent with the present invention may generate a promotional offer by (i) accepting information concerning at least one of (A) a search query entered, at a client device, by a user, (B) an item or establishment which is the subject of a search result selected by a user using a client device, and (C) one or more items or establishments which are elements of a shopping session summary provided to a user via a client device, (ii) determining a promotional offer to serve using at least the accepted search query information, and (iii) determining terms of the promotional offer using at least one of (A) an inventory, at an establishment associated with the promotional offer, of the goods which the promotional offer concerns, (B) a capacity, at an establishment associated with the promotional offer, to provide the services which the promotional offer concerns, (C) a level of excess capacity, at an establishment associated with the promotional offer, to provide the services which the promotional offer concerns, (D) a perishability of goods which the promotional offer concerns, and (E) a remaining shelf-life of goods which the promotional offer concerns.

### § 3. BRIEF DESCRIPTION OF THE DRAWINGS

FIG. 1 is a bubble diagram of operations that may be performed, and information that may be used and/or generated, in exemplary embodiments consistent with the present invention.

FIG. 2 is a block diagram which illustrates how different client devices at different locations can share search facilities in a manner consistent with the present invention.

FIG. 3 is a flow diagram of an exemplary method that may be used to control various shopping session operations in a manner consistent with the present invention.

FIG. 4 is a flow diagram of an exemplary method that may be used to perform product and/or service search operations in a manner consistent with the present invention.

FIG. 5 is a flow diagram of an exemplary method that may be used to generate a shopping session summary in a manner consistent with the present invention.

FIG. 6 is a flow diagram of an exemplary method that may be used to generate promotional offers (e.g., ads, discount coupons, etc.) dynamically, in a manner consistent with the present invention.

FIG. 7 is a block diagram of exemplary apparatus that may be used to perform operations and/or store information in exemplary embodiments consistent with the present invention.

FIG. 8 illustrates an exemplary environment in which an in-store search appliance, consistent with the present invention, may be used.

FIG. 9 is a flow diagram of an exemplary method that may be used to provide in-store item (e.g., products and/or services) search operations in a manner consistent with the present invention.

FIGS. 10 through 23 are screens illustrating exemplary documents (e.g., Web Pages) of an exemplary user interface that is consistent with the present invention.

### § 4. DETAILED DESCRIPTION

The present invention may involve novel methods, apparatus, message formats, and/or data structures for helping users to shop for goods and/or services. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention as any patentable subject matter described.

In the following, definitions that may be used in the specification are provided in § 4.1. Then, exemplary embodiments consistent with the present invention are described in § 4.2. An example illustrating operations in an exemplary embodiment consistent with the present invention is provided in § 4.3. Finally, some conclusions regarding the present invention are provided in § 4.4.

Although many of the following examples refer to goods, the embodiments consistent with the present invention need not be limited to goods and may concern services instead of, or in addition to, goods.

### § 4.1 Definitions

An “item” may include a good or a service.

“Facilities” include apparatus for performing various operations. Facilities may include, for example, computer servers and appropriate program instructions.

An “establishment” may be a store, a restaurant, a vender, a service provider, etc. A “store” or “vendor” is an establishment that sells or rents goods, including, for example, stores with physical locations where items are purchased. Stores can also include online stores, catalog sellers, and individuals. Similarly, a “service provider” is an establishment that sells services. Service providers may have physical and/or virtual locations.

A shopping “trip” or “session” may include a defined time period during which an individual may shop for items. The time period may be defined by, or inferred from, context. For example, in the context of a mall, a shopping session may be shopping from a given time, to when an individual leaves the mall, or to when the mall closes. As another example, in the context of an airport, a shopping session may be shopping from a given time to when an individual is to board an airplane. As yet another example, in the context of a resort or an island, a shopping trip may be shopping from a given time, to when an individual is scheduled to leave the resort or island. “Shopping trip” and “shopping session” may often be used interchangeably in the specification.

A “promotional offer” may be a discount offer, such as a coupon for example, an advertisement, etc.

“User information” may include user behavior information and/or user profile information.

A “user device” may be a device that a user interacts or interfaces with. A user device may be owned by the user, or may be owned by a third party. Examples of user devices include kiosks, wireless information appliances, etc.

### § 4.2 EXEMPLARY EMBODIMENTS CONSISTENT WITH THE PRESENT INVENTION

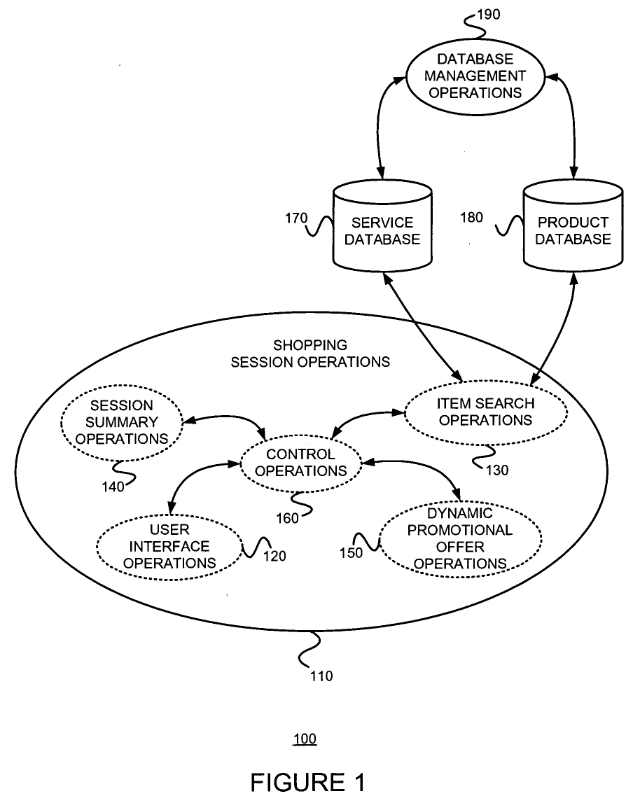

FIG. 1 is a bubble diagram of operations that may be performed, and information that may be used and/or generated, in exemplary embodiments 100 consistent with the present invention. Shopping session operations 110 may use one or both of service information database 170 and product database 180. Database management operations 190 may maintain information in one or both of the databases 170 and 180.

Shopping session operations 110 may include control operations 160, user interface operations 120 and one or more of item search operations 130, session summary operations 140, and dynamic promotional offer operations 150. The various operations 120, 130, 140, 150 may interact with one another via control operations 160.

Item search operations 130 may be used to allow a user to search information in the service database 170 and/or the product database 180. More specifically, these operations 130 may be used to allow a user to search for products and/or services available at a given location (e.g., a store, a mall, a resort, an island, a transportation terminal, a shopping district, etc.) In at least some embodiments consistent with the present invention, the user may select products and/or services that they are interested in purchasing. In at least some other embodiments consistent with the present invention, the user may select establishments that they are interested in visiting. As will be described in more detail in § 4.2.1 below, the databases 170/180 may store information on a per location (e.g., store, mall, resort, island, a transportation terminal, shopping district, etc.) basis, or may store information across a number of different locations. Further, as will be described in more detail in § 4.2.1 below, the databases 170/180 may be maintained at each of various locations, and/or may be maintained at a facility or facilities servicing a plurality of locations.

Recall that at least some embodiments consistent with the present invention allow a user to select products and/or services, and/or allow a user to select establishments that they are interested in visiting. Session summary (or trip) operations 140 may be used to provide the user with a summary of the products, services, and/or establishments that they selected. In at least some embodiments consistent with the present invention, the user may edit the session summary. In at least some embodiments consistent with the present invention, the session summary operations 140 may perform one or more additional operations such as, for example, determining an optimal shopping route for the shopper, determining directions or a map for the shopper, etc.

Dynamic promotional offer operations 150 may be used to generate promotional offers. As described in more detail in § 4.2.3 below, in at least some embodiments consistent with the present invention, such promotional offers may be generated using various information, such as user selections of products, services, and/or establishments, search query information, search result information, session information, user information, relationships (e.g., established by hand mapping, collaborative filtering, conceptual clustering, etc.) of products or services, etc.

User interface operations 120 may be used to allow shoppers to interact with, either directly or via control operations 160, one or more of the foregoing operations 130, 140, 150.

### § 4.2.1 Exemplary Data Structures

Still referring to FIG. 1, service database 170 may include a number of entries, each of which may include one or more of establishment name, establishment location, establishment hours, establishment rating or reviews, service categories, wait times for services, links to further information, etc. For example, in the context of dining services, an entry in a service database may include a cuisine category, a restaurant name, particular items on the menu, information about such items (e.g., ingredients, how prepared, price), a location, a rating and/or review, typical wait times to be seated or to pickup a take-out order, etc. Such information may be augmented with more current information, such as daily specials, current wait times to be seated or to pick up an order, current promotional offers, etc. A search may analyze one or more of such fields of an entry.

The product database 170 may include a number of entries, each of which may include one or more of the name of an establishment(s) that carries the product, establishment location(s), establishment(s) hours, establishment(s) ratings, product ratings, product costs, catalog entries or descriptions, etc. Such information may be augmented with more current information such as daily specials, current available inventory (e.g., per item, per size, per color or finish, etc.), promotional offers, etc.

### § 4.2.2 Exemplary System Architecture

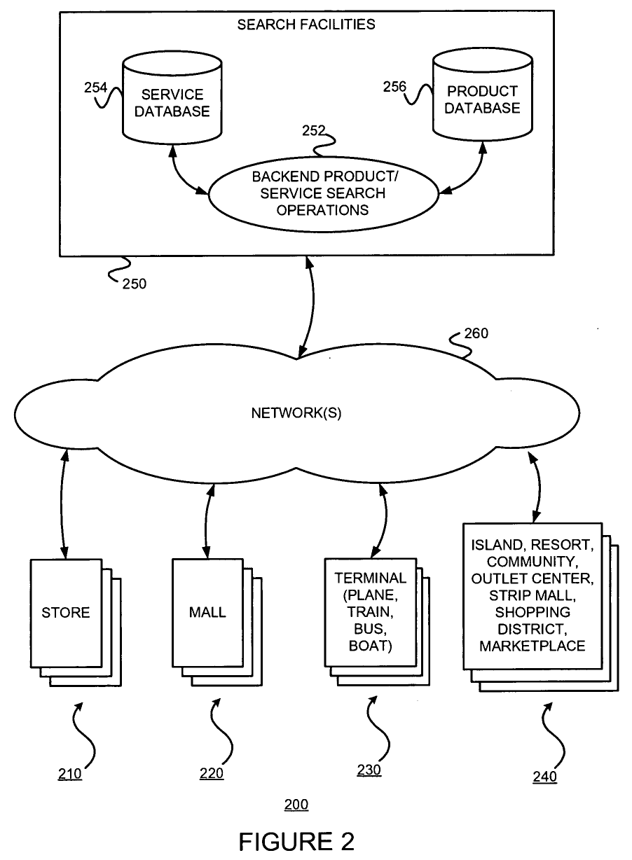

FIG. 2 is a block diagram which illustrates an exemplary architecture 200 in which different user (e.g., client) devices (not shown) at different locations 210, 220, 230, 240 can share search facilities 250 in a manner consistent with the present invention. More specifically, search facilities 250 may include backend product/service search operations 252. These operations 252 may interact with service database 254 and/or product database 256. One or more stores 210, one or more malls (e.g., indoor, outdoor, strip, etc.) 220, one or more transportation terminals (e.g., train station, bus terminal, airport, boat port) 230, and/or one or more other shopping areas (e.g., islands, resort communities, outlet centers, shopping districts, marketplaces, etc.) 240 may include client devices which interact with backend product/service search operations 252 via one or more networks 260, such as the Internet for example. More specifically, user devices such as kiosks, fixed terminals, wireless devices, or access points (e.g., wireless access points) may be provided in or at stores, indoor malls, outdoor malls, strip malls, airports, train stations, boat ports, bus terminals, islands, resort communities, shopping districts, marketplaces, etc. Naturally, any combination of stores, malls, transportation terminals, etc. can share service and/or product information.

Alternatively, at least some stores, malls, etc. may manage their own service and/or product information (which may be provided on site or off-site). In at least some embodiments consistent with the present invention, product and/or service information may be distributed, with some information being stored and managed centrally, and with other information stored and/or managed locally. For example, a chain store such as Tower Records may store and manage information about various compact disks that its stores offer centrally, while storing and managing information about inventory, and specials at a particular store locally. As another example, a chain restaurant such as PF Chang's China Bistro may store and manage information about its main menu items centrally, while storing and managing information about wait times and seafood specials locally. As yet another example, a third party may store certain product or service information (e.g., product specification, reviews, etc.) centrally, while a particular establishment may store certain other information (e.g., inventory, price, proprietary information) locally.

Examples of an island include Grand Cayman Island, The Island of Kauai, etc. Examples of resorts include all Disney Orlando resorts, Disney Epcot resorts, the Atlantis resort in the Bahamas, Martha's Vineyard, Hilton Head, N.C., Lake Tahoe, etc. Examples of shopping neighborhoods or districts include 5^{th} Avenue, N.Y., Napa Valley, Calif., the Georgetown section of Washington, D.C., an ocean boardwalk, etc. Examples of marketplaces include flea markets, festivals (e.g., music festivals, theater festivals, film festivals, etc.), fairs, amusement parks, theme parks, etc.

### § 4.2.3 Exemplary Methods

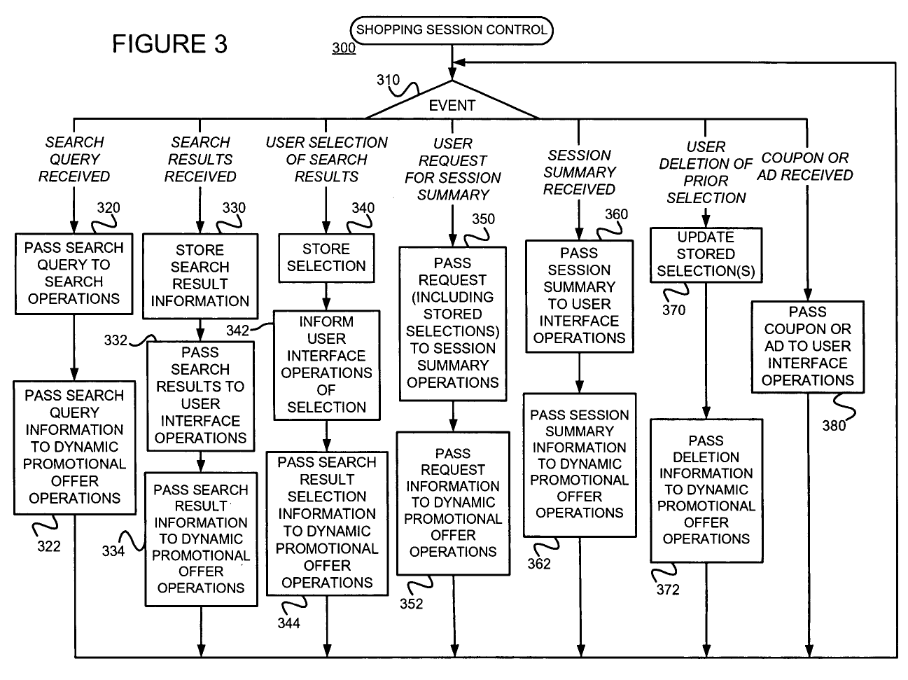

FIG. 3 is a flow diagram of an exemplary method 300 that may be used to control various shopping session (or trip) operations in a manner consistent with the present invention. As indicated by event block 310, various branches of the method 300 may be performed in response to the occurrence of various events. For example, if a search query is received (e.g., from user interface operations), the method 300 may pass the search query to search operations (Block 320), before branching back to event block 310. In addition, the method 300 may pass search query information to dynamic promotional offer operations. (Block 322)

Referring back to event block 310, if search results are received (e.g., from product/service search operations), the method 300 may store information pertaining to such search results (Block 330) and pass the search results to user interface operations (Block 332), before branching back to event block 310. In addition, the method 300 may pass information pertaining to the search results (which may be the same as, and/or different from that information stored) to dynamic promotional offer operations. (Block 334) Referring back to event block 310, if user selection of (e.g., some element of) search results occurs, the method 300 may store the selection (Block 340) and inform user interface operations of the selection (Block 342), before branching back to event block 310. In addition, the method 300 may pass information pertaining to the selection (which may be the same as, and/or different from that information stored) to dynamic promotional offer operations. (Block 344)

Referring back to event block 310, if a user request for session summary occurs, the method 300 may pass the request (perhaps including the stored selections) to session summary operations (Block 350), before branching back to event block 310. In addition, the method 300 may pass information pertaining to the session summary request to dynamic promotional offer operations. (Block 352) Referring back to event block 310, if a session summary is received, the method 300 may pass session summary information to user interface operations (Block 360), before branching back to event block 310. In addition, the method 300 may pass session summary information to dynamic promotional offer operations. (Block 362)

Referring back to event block 310, if a user deletion of a prior selection occurs, the method 300 may update the stored selection (Block 370. Recall, e.g., block 330.), before branching back to event block 310. In addition, the method 300 may pass information pertaining to the deletion to dynamic promotional offer operations. (Block 372)

Finally, referring back to event block 310, if a promotional offer such as a coupon or ad is received, the method 300 may pass the promotional offer to user interface operations (Block 380) before the method 300 branches back to event block 310.

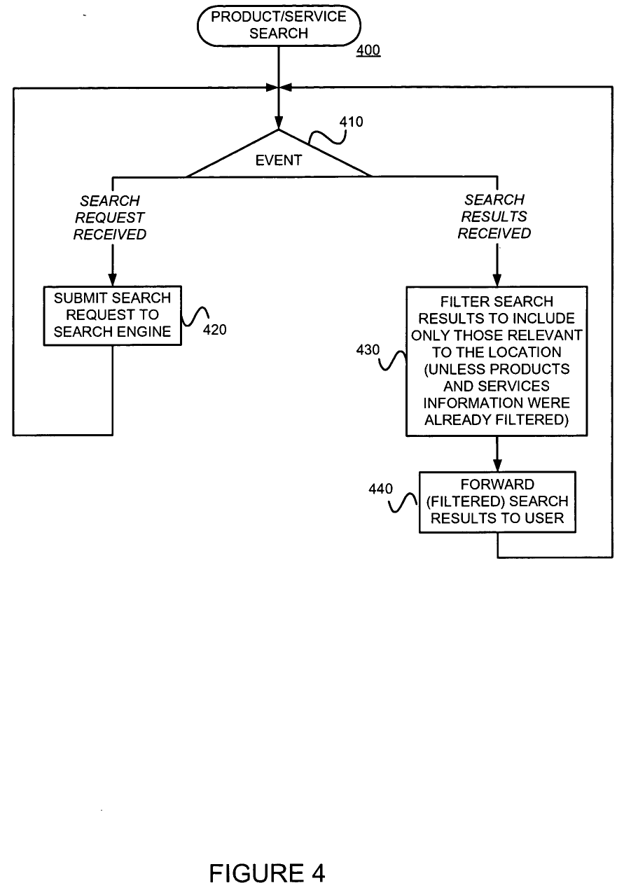

FIG. 4 is a flow diagram of an exemplary method 400 that may be used to perform product and/or service search operations in a manner consistent with the present invention. As indicated by event block 410, various branches of the method 400 may be performed in response to the occurrence of various events. For example, if a search request is received, the method 400 may submit the search request to a search engine or facility (Block 420) before the method 400 branches back to event block 410. Referring back to event block 410, if search results are received, the method 400 may filter the search results to remove those not pertinent to the relevant location (Block 430), and the (filtered) search results may be forwarded to the user (e.g., via control operations and user interface operations) (Block 440), before the method 400 branches back to event block 410. Referring back to block 430, it is possible that back-end product and/or service search operations may have already filtered the search results to include only those relevant to the location of interest, or a location specific database of product and/or services may have been searched. If so, the act in block 430 may be skipped.

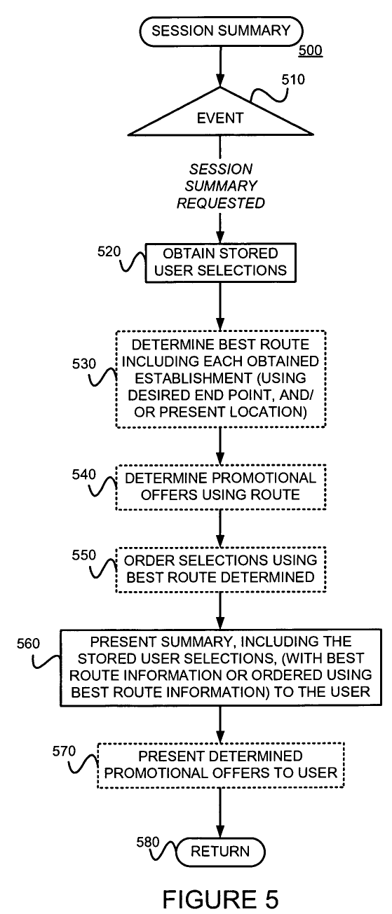

FIG. 5 is a flow diagram of an exemplary method 500 that may be used to generate a shopping session summary in a manner consistent with the present invention. As indicated by event block 510, the main acts of the method 500 may be performed when a session summary is requested. For example, the method 500 may obtain stored user selections (Block 520) and present a summary including information from the stored user selections, to the user (Block 560) before the method 500 is left (Node 580).

Still referring to FIG. 5, in at least some embodiments consistent with the present invention, the method 500 may also determine a route, such as a best route, including each obtained establishment. (Block 530) At least some embodiments consistent with the present invention may use known “traveling salesman” algorithms to determine the best route. The present location of the user (which may be determined to be the location of the client device such as a fixed terminal, such as a kiosk for example, or a portable client, such as a global positioning satellite (GPS) enabled wireless device for example) may be used when determining the best route. Alternatively, or in addition, a final destination (e.g., a particular exit, a car parking location, a valet location, a subway station location, etc.) may be used when determining the best route. If a best route is determined, it may be presented to the user (expressly as a map, and/or implicitly in the ordering of establishments. Alternatively, or in addition, other constraints (e.g., store hours, time of expiration of a promotional offer, lunch time, dinner time, paid route inclusion by an establishment, paid route competitor exclusion, etc.) may be considered when determining a best route.

In at least some embodiments consistent with the present invention, promotional offers may be presented to the user. (Block 570) These may have been determined based on session information. Alternatively, or in addition, these may have been determined using route information. (Block 540)

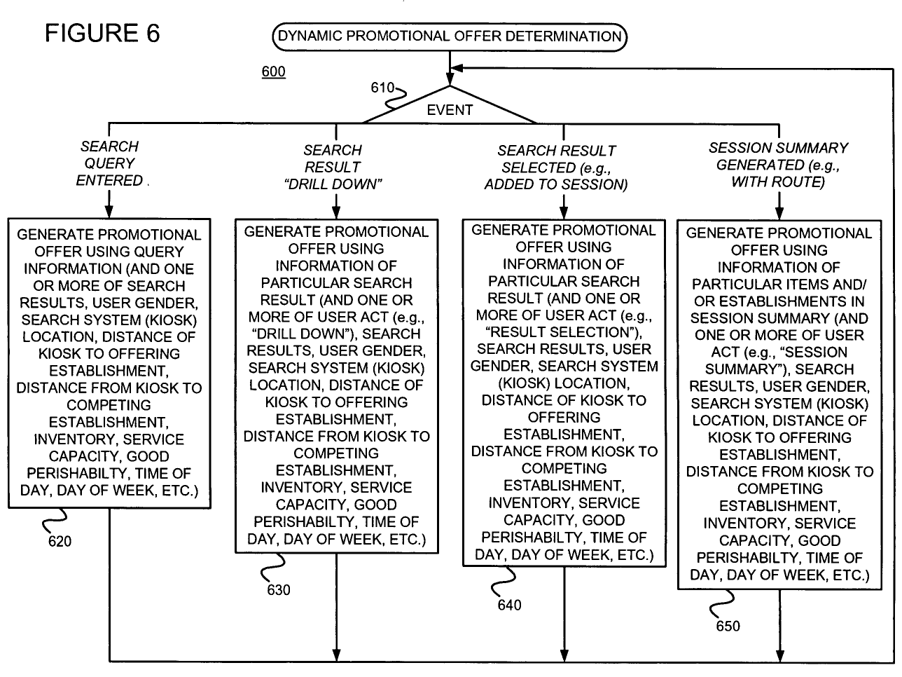

FIG. 6 is a flow diagram of an exemplary method 600 that may be used to generate promotional offers dynamically, in a manner consistent with the present invention. As indicated by event block 610, various branches of the method 600 may be performed in response to the occurrence of various events. For example, if a search query was entered, the method 600 may generate (or score, or order) one or more promotional offers using query information (which may be presented to the user via user interface operations) (Block 620) before branching back to event block 610.

The promotional offer(s) may also be generated (or scored, or ordered) using one or more of search result information, user gender (and/or some other user information), search system (e.g., kiosk) location, distance of kiosk to offering establishment, distance from kiosk to a competing establishment, inventory, service capacity, excess service capacity, good perishability, time of day, day of week, etc. For example, if the offering establishment is closer to the kiosk, the promotional offer may be less aggressive (e.g., less of a discount) than if the offering establishment is further from the kiosk. Also, if a competing establishment is near the kiosk (or closer, or a closer by a predetermined absolute or relative value), the promotional offer may be more aggressive than otherwise. As yet another example, if product inventory is high, or is experiencing a slower than desired turnover, or if floor space is needed, the promotional offer may be more aggressive (e.g., larger discount, larger time window, etc.) than it would be otherwise. As still another example, if a service capacity is high (idle cooks, idle hairdressers, idle sales associates, etc.), the promotional offer may be more aggressive than it would be otherwise. As yet still another example, if a perishable item (e.g., baked goods, prepared foods, etc.) is nearing the end of its shelf life, the promotional offer may be more aggressive than it would be otherwise.

Referring to event block 610, if the user “drills down” into a particular search result (that is, the user might request more information about a particular item even before deciding whether to add it to their shopping list), the method 600 may generate (or score, or order) one or more promotional offers using information from the particular search result or search result element (which may be presented to the user via user interface operations) (Block 630) before branching back to event block 610. The promotional offer(s) may also be generated (or scored, or ordered) using one or more of the factors discussed above with reference to block 620. In addition, the promotional offer(s) may be generated (or scored, or ordered) in consideration of the user act (i.e., drilling down). For example, an establishment may want to further entice a user that has shown a moderate degree of interest in a good or service with a promotional offer (e.g., of a larger amount). As a counter-example, an establishment may not want to discount an item as aggressively if a user has already shown some interest in the item.

Referring to event block 610, if the user selects a particular search result or an element of a search result, the method 600 may generate (or score, or order) one or more promotional offers using information from the particular search result (which may be presented to the user via user interface operations) (Block 640) before branching back to event block 610. The promotional offer(s) may also be generated (or scored, or ordered) using one or more of the factors discussed above with reference to block 620. In addition, the promotional offer(s) may be generated (or scored, or ordered) in consideration of the user act (i.e., search result or search result element selection). For example, an establishment may want to further entice a user that has shown a serious degree of interest in a good or service with a promotional offer (e.g., of a larger amount). As a counter-example, an establishment may not want to discount an item as aggressively if a user has already shown strong interest in the item. As can be appreciated from the foregoing, an establishment may find it desirable to discount items that have been “drilled down” on more aggressively than those items that have already been selected.

Finally, referring to event block 610, if a session summary (e.g., with a route) is generated, the method 600 may generate (or score, or order) one or more promotional offers using information of particular items and/or establishments in the session summary (which may be presented to the user via user interface operations) (Block 650) before branching back to event block 610. The promotional offer(s) may also be generated (or scored, or ordered) using one or more of the factors discussed above with reference to block 620. In addition, the promotional offer(s) may be generated (or scored, or ordered) in consideration of the user act (i.e., session summary selected). For example, an establishment may want to further entice a user that has shown a moderate degree of interest in a good or service with a promotional offer (e.g., of a larger amount), particularly if the user “drilled down” on the item but did not select the item. As another example, an establishment may not want to discount an item as aggressively if a user has already shown a strong interest in the item by selecting it. The promotional offer(s) may also be generated (or scored, or ordered) using a determination of whether the establishment is on (or within a line-of-sight of) a determined best route, whether a competing establishment is on (or within a line-of-sight of) the determined best route, etc.

A coupon or promotional offer may include a “code” to permit conversion tracking (e.g., whether or not the shopper uses a coupon. Stores might pay a third party operator of the shopping session operations using conversions, or some derivative of conversions.

As should be appreciated from the foregoing, various information may be used to determine either or both of (a) whether or not to provide a promotional offer (e.g., a discount coupon), and (b) if a promotional offer is to be provided, the terms (e.g., amount or percentage discount, time period of offer, etc.) of the offer.

Terms of a promotional offer, or the basis on which such terms are determined may be randomized to some degree. Doing so may prevent “gaming” the system to obtain better terms. Doing so may also be used by establishments to experiment with terms.

### § 4.2.4 Apparatus

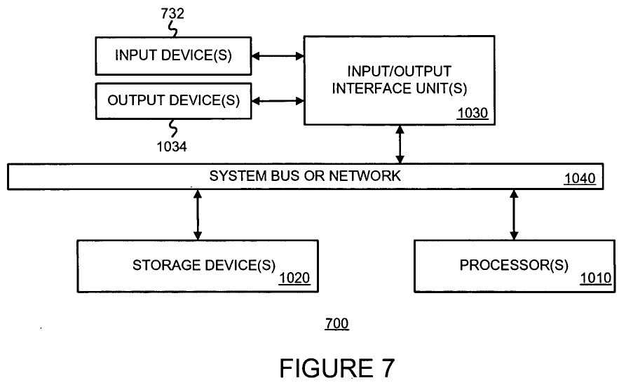

FIG. 7 is high-level block diagram of a machine 700 that may perform one or more of the operations discussed above. The machine 700 includes one or more processors 710, one or more input/output interface units 730, one or more storage devices 720, one or more system buses and/or networks 740 for facilitating the communication of information among the coupled elements. The networks 740 may include one or more networks interfaces for communicating with an intranet and/or the Internet. Alternatively, or in addition, input/output interface units 730 may include such network interfaces. One or more input devices 732 and one or more output devices 734 may be coupled with the one or more input/output interfaces 730.

The one or more processors 710 may execute machine-executable instructions (e.g., C or C++ running on the Solaris operating system available from Sun Microsystems Inc. of Palo Alto, Calif., the Linux operating system widely available from a number of vendors such as Red Hat, Inc. of Durham, N.C., Java, assembly, Perl, etc.) to effect one or more aspects of the present invention. At least a portion of the machine executable instructions may be stored (temporarily or more permanently) on the one or more storage devices 720 and/or may be received from an external source via one or more input interface units 730.

In one embodiment, the machine 700 may be one or more conventional personal computers (e.g., in a kiosk form factor), mobile telephones, PDAs, etc. If the machine is a mobile telephone or PDA, it may be GPS-enabled or include some other means for determining its absolute or relative position. In the case of a conventional personal computer, the processing units 710 may be one or more microprocessors. The bus 740 may include a system bus. The storage devices 720 may include system memory, such as read only memory (ROM) and/or random access memory (RAM). The storage devices 720 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media, etc.

A user may enter commands and information through input devices 732, such as a keyboard and pointing device (e.g., a mouse) for example. Other input devices such as a touch screen, a microphone, a joystick, a game pad, a satellite dish, a scanner, or the like, may also (or alternatively) be included. These and other input devices are often connected to the processing unit(s) 710 through an appropriate interface 730 coupled to the system bus 740. The output devices 734 may include a monitor or other type of display device, which may also be connected to the system bus 740 via an appropriate interface. In addition to (or instead of) the monitor, the machine may include other (peripheral) output devices (not shown), such as speakers and printers for example.

Referring back to FIG. 1, one or more machines 700 may be used as to perform one or more of the shopping session operations 110.

### § 4.2.5 Refinements and Alternatives

Although route-based promotional offers were described with respect to routes within a store, or other market, such promotional offers may be determined using any route information. For example, driving direction Websites currently generate driving routes. Such Websites may provide promotional offers based on the endpoints of the route. Embodiments consistent with the present invention may be used to generate promotional offers (e.g., for motels, hotels, restaurants, fuelling stations, etc.) based on such driving routes, including points on the route other than the end points.

The route may be a route that best meets some policy goals. One policy goal might be to determine a shortest path. Another policy goal might be to determine a shortest path which also routes a shopper past certain establishments. Other policy goals are possible. It may be useful to ensure that such policies do not inconvenience a shopper too much. For example, it may be desirable to have the best route fall within a certain distance bounds with respect to a shortest path (e.g., best route can be no more than 110% of the distance of the shortest path). In some instances, the route might not strictly meet all of the policy goals best. Accordingly, the route may be considered to be a recommended route.

### § 4.2.5.1 IN-STORE SEARCH APPLIANCE EMBODIMENTS

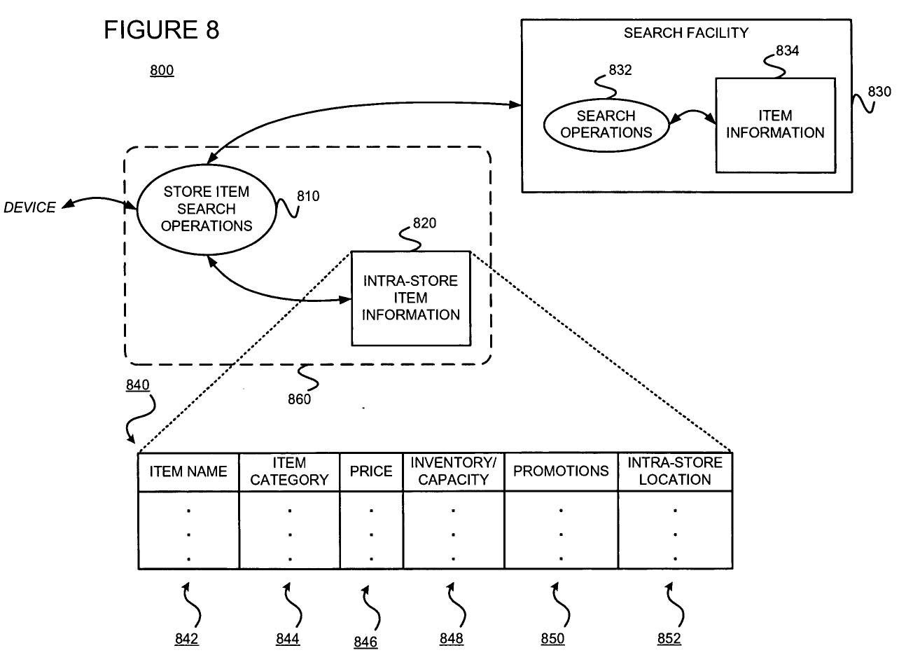

FIG. 8 illustrates an exemplary environment 800 in which an in-store search appliance, consistent with the present invention, may be used. The environment 800 may include store item (e.g., product and/or service) search operations 810, intra-store item information 820 and a search facility 830. The store item search operations 810 may accept item search queries from a device such as a kiosk or a wireless device. The store item search operations 810 may then find one or more relevant items, and associated information, using intra-store item information 820. The store item search operations 810 may then get additional item information for one or more returned items using search facility 830. The search facility 830 may include search operations 832 and item information 834.

In at least one embodiment consistent with the present invention, the intra-store item information 820 may be stored in an exemplary table data structure 840, including a number of entries. Each of the entries may include one or more of an item name 842, an item category 844, a price 846, product inventory or service capacity (in-store) 848, promotions (e.g., coupons, rebates, etc.) 850 and an intra-store location 852. In at least one embodiment consistent with the present invention, the intra-store location information 852 may include a department in which the item is located, on aisle on which the item is located, a shelf on which a product is located, etc. A graphical depiction of the location of the item in the store, with respect to the device, may be provided.

The item information 834 may differ from intra-store item information 820. For example, the product information may include more or less items than the intra-store item information 820. Thus, the store can use item information 834, which may be provided by a third party service provider, to supplement information about items it sells. In this way, the store can help customers to locate items within the store, without needing to enter and maintain additional information such as item specifications, item reviews, etc. In at least some embodiments consistent with the present invention, the item information 834 might not include price(s), or search operations 832 (or some other operations, not shown) may filter out such price information. In at least some embodiments consistent with the present invention, the item information might not include information about competing establishments that also sell item, or search operations 832 (or some other operations, not shown) may filter out such information.

As indicated by dashed-line block 860, store item search operations 810 and/or intra-store item information 820 may be maintained by and/or provided at a store. This allows stores to maintain proprietary and/or sensitive information, without allowing access by a third party (e.g., the search facility).

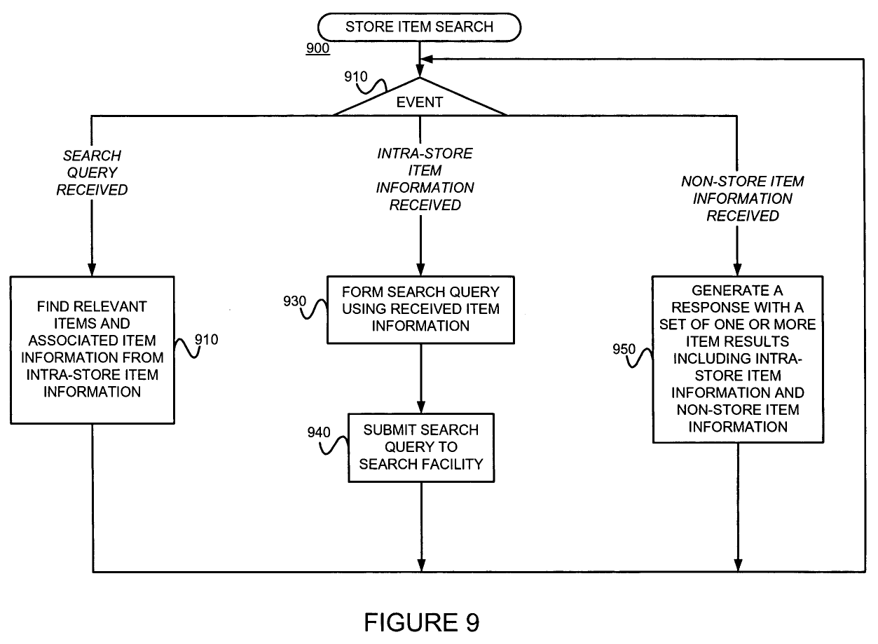

FIG. 9 is a flow diagram of an exemplary method 900 that may be used to provide in-store item search operations in a manner consistent with the present invention. Various branches of the exemplary method 900 may be performed in response to various events that may occur. (Block 910) For example, if a search query is received (e.g., from an in-store device), relevant items and associated item information may be found from intra-store item information using the search query (Block 920), before the method 900 goes back to event block 910. If intra-store item information is received, a search query may be formed using the received item information (Block 930) and the search query may be submitted to a search facility (Block 940), before the method 900 goes back to event block 910. Finally, if non-store item information is received (e.g., from the search facility), a response is generated with a set of one or more item results (Block 950) before the method 900 continues back to event block 910. Each of the item results may include intra-store item information (Recall, e.g., 820 of FIG. 8.) and non-store item information (Recall, e.g., 834 of FIG. 8.).

### § 4.3 EXAMPLES OF OPERATIONS IN AN EXEMPLARY EMBODIMENT CONSISTENT WITH THE PRESENT INVENTION

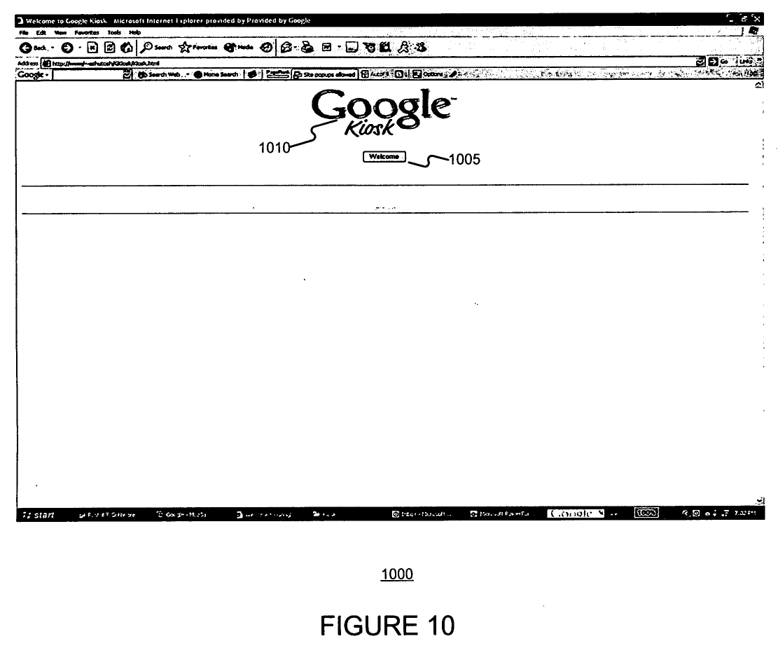

FIGS. 10 through 23 illustrate exemplary screens corresponding to operations of an exemplary user interface that is consistent with the present invention. Specifically, these Figures depict screens of exemplary documents (e.g., Web Pages) corresponding to various states of a user interface that may be provided on a kiosk in a shopping mall for example. One or more kiosks may be located in a mall, preferably at entrance points of the mall.

FIG. 10 illustrates a screen 1000 of an exemplary introduction Webpage. The exemplary screen 1000 includes a Google kiosk logo 1010 and a (selectable and executable) welcome button 1005.

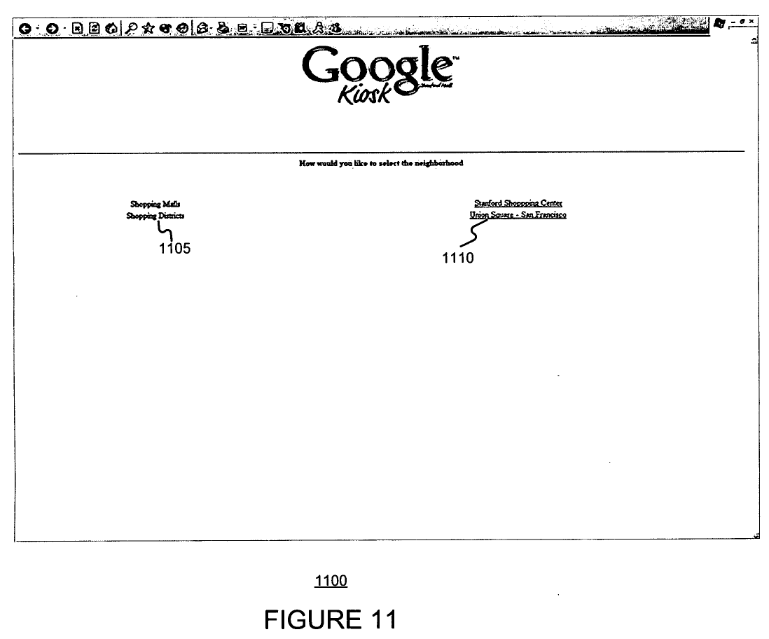

In the exemplary user interface, if the user selects (e.g., clicks on) the welcome button 1005, the screen 1100 illustrated in FIG. 11 is rendered. The screen 1100 (e.g., of a document or page) presents a list 1105 with one or more shopping malls and shopping districts 1105, along with (selectable and executable) names of these malls and districts 1110. For instance, the screen 1100 lists the Stanford shopping center as the mall (which is also the mall at which the user is presently using the kiosk) and Union Square San Francisco as the shopping district. Other malls and shopping districts could be listed. The user can select one of the listings.

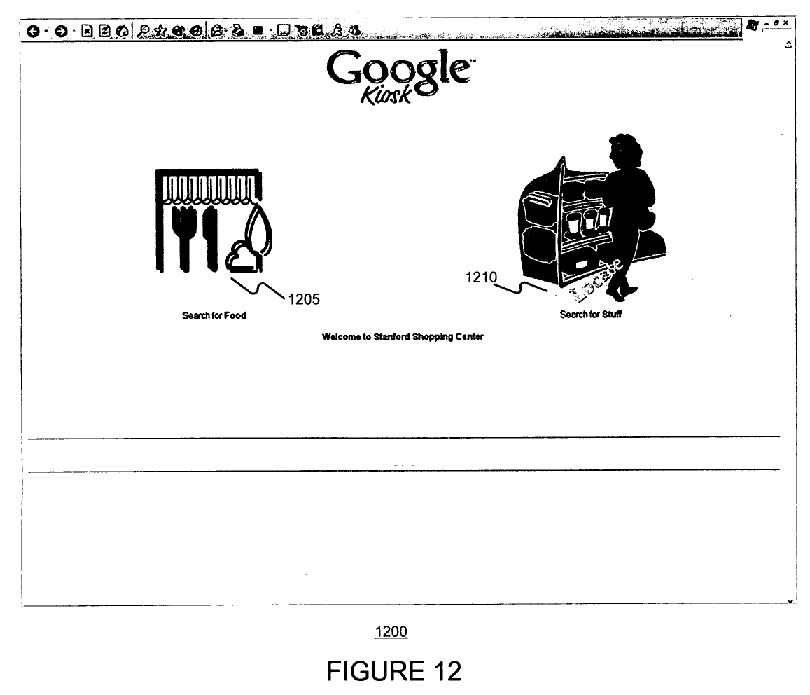

FIG. 12 illustrates a screen 1200 (e.g., a document page) of displayed in response to a user selection of the Stanford Shopping Center as the mall from the list 1110 of screen 1100. This screen 1200 welcomes the user to the shopping mall, and offers the options of searching for food 1205, or searching for products 1210. Other options may be available instead of, or in addition to, these options. The options presented may depend on the shopping location and other factors.

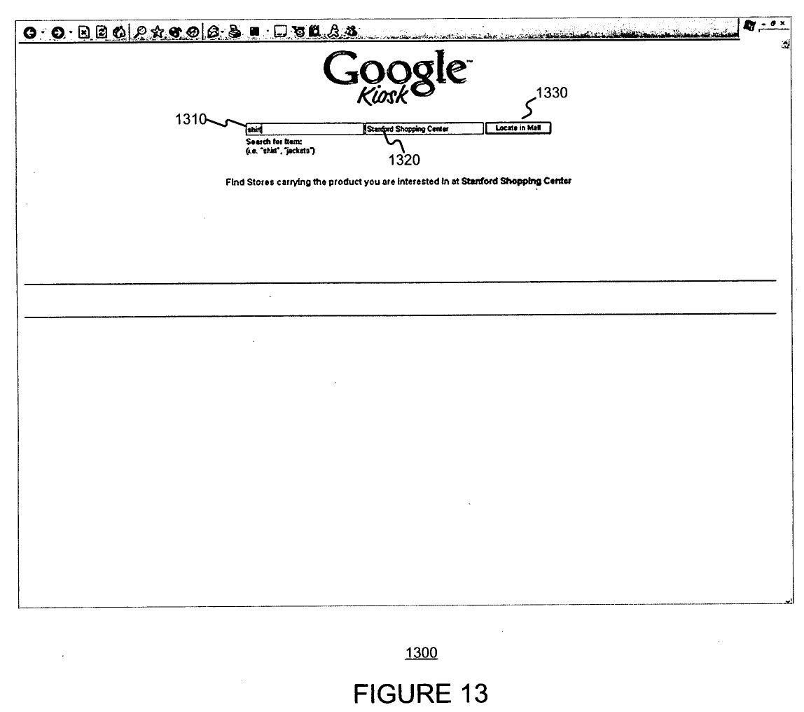

Assume that the user selects “search for stuff” selectable and executable image 1210. A new screen 1300 (e.g., of a new document or page) is depicted by FIG. 13. This screen 1300 includes a query box 1310, a box 1320 to filter results using location, and a selectable and executable button 1330 to initiate a search. A user may simply enter their search in the search query box 1310 and select the “locate in mall” button 1330. (Note that other locations can be searched by entering different locations in box 1320.) In this example, the user has entered the word “shirt” in box 1310.

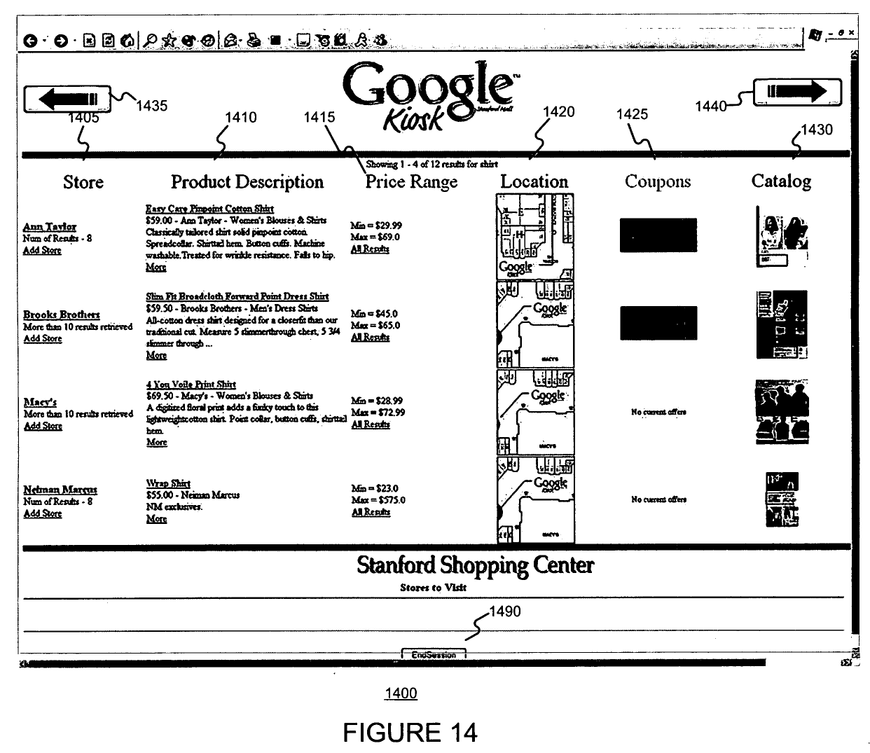

FIG. 14 is an exemplary search results screen 1400 (e.g., of a new document or page). In this example, the search results are listed in a table, with text elements referred to as selectable and executable text elements with various different results corresponding to different rows. In this example, each entry may include store information and selectable and executable (text) elements (referred to simply as “tool” elements below) 1405, item description information and tool elements 1410, price range information and tool elements 1415, location information 1420, promotional offers as coupons 1425 and catalog information 1430. Of course, the present invention is not limited to these specific fields, and other listed information might be displayed instead of, or in addition to, at least some of this information.

The first column 1405 of the table includes store information and tool elements. The store information may include the name of the store and the number of product or service matches (e.g., to the search query “shirt”) that the item search operations determined for the store. The user can add the store to its shopping session by selecting the “Add Store” text tool element. Additional information about the store (e.g., hours of operation, location, etc.) may be determined by selecting the hypertext store name. Thus, in this example, column 1405 lists all of the stores in the Stanford Shopping Center that carry shirts, as well as the number of “shirts” that each store has.

The second column 1410 of the table includes descriptions of item(s) corresponding to each store from the first column 1405. From this column, the user can get a detailed description of the item along with the price. Links are also available within each item description 1410 to allow the user to obtain more detailed information or to see more items, sold by the store, that match the query. In at least some exemplary embodiments, such as the above shown, only one item per store is shown. This may be the best scoring matching item, where the score may be a function of one or more of (i) relevance to the search query, (ii) popularity, (iii) applicable promotions, etc.

The third column 1415 of the table includes of a list of price ranges corresponding to the matching product offerings in each of the stores of the first column 1405. That is, if a store has four types of shirts, one for $45.00, one for $49.00, one for $50.00, and one for $60.00, the range would be Min=$45.00 to Max=$60.00. Moreover, selectable and executable “All Results” text links allow the user to view the price of each individual product included in the results.

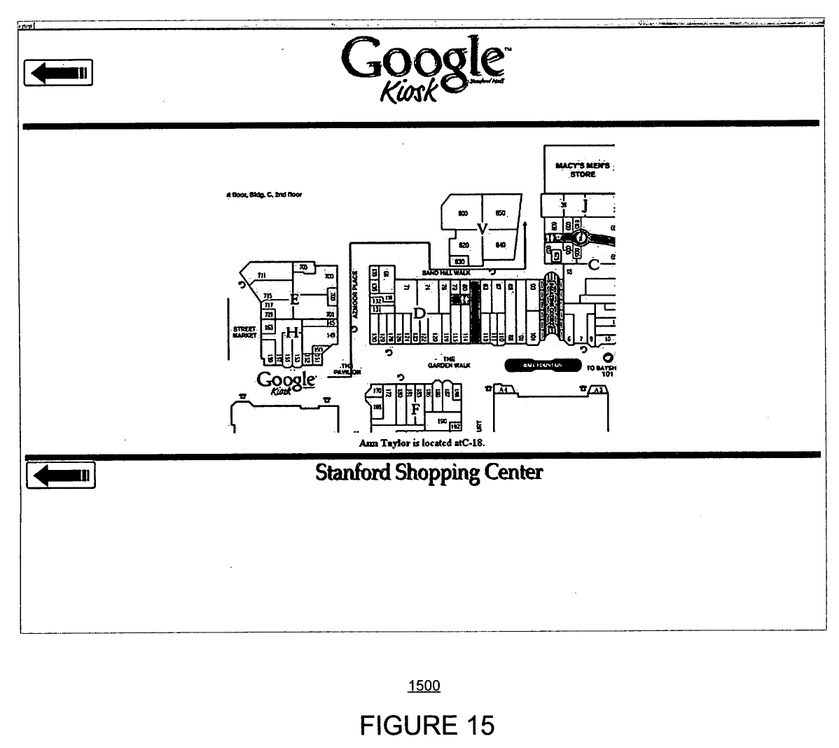

The fourth column 1420 of the table includes a graphical depiction of store locations within the mall. In the depicted embodiment, the graphical depiction is a small map including a highlighted route that displays the path to the store selected by the user to visit. The user can follow the highlighted route in order to get from the kiosk to the store. In addition, the map may be interactive, allowing a user to get (e.g., by selecting one of the smaller maps) a display of a larger, more detailed, map with zooming capabilities. FIG. 15 illustrates a display screen 1500 including such an exemplary larger, more detailed, map.

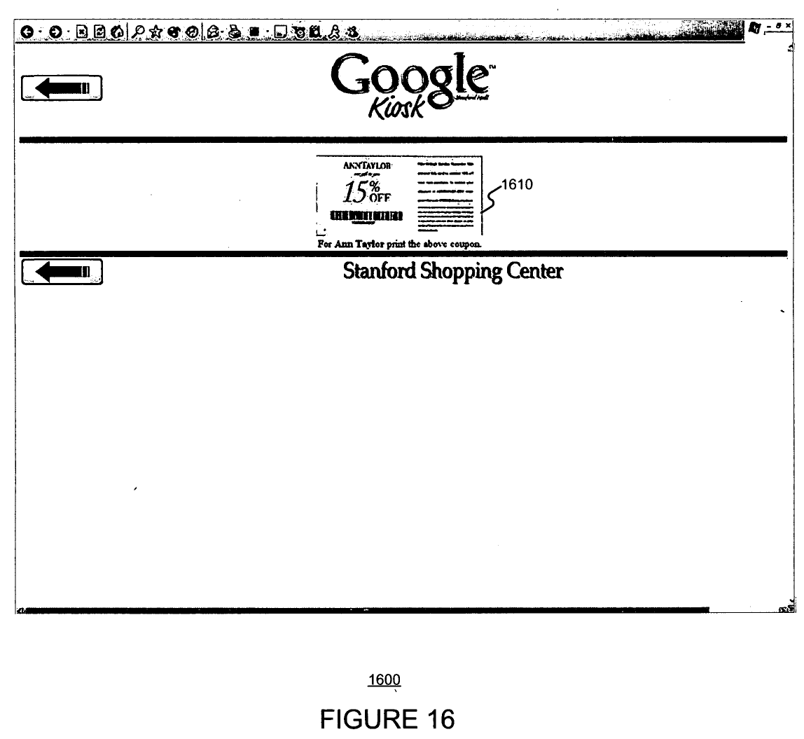

Referring back to FIG. 14, the fifth column 1425 of the table may include one or more promotional offers (e.g., coupons in the case of this example). The promotional offers may be available to the public in general, or may be made available exclusively to users of the kiosk. As shown, promotional offers might not always be available every day in every store. Whether or not to provide promotional offers, and/or the terms of such promotional offers, may be determined dynamically, as described above with reference to FIG. 6. In at least one embodiment consistent with the present invention, the coupons include links. In such embodiments, if the user selects the linked coupon, another Webpage depicting the actual coupon may be loaded. For example, assume that the user has selected the Ann Taylor coupon. FIG. 16 depicts an exemplary display 1600 including the coupon 1610 corresponding to the user selection. This coupon 1610 depicts the offer along with the store name and pertinent information such as any other regular coupon. In at least some embodiments consistent with the present invention, a kiosk (or some other client device) has printing capabilities. This allows the user to print the coupon and present it to the corresponding store for discount. (Note that such a printer may be used to print a map with a route.) In alternative embodiments consistent with the present invention, the coupon may be emailed or otherwise transmitted to the store, perhaps along with user identification information such as a name, an ID number, and/or an image of the user. In such an alternative embodiment, the kiosk (or other client device) does not need a printer, but may include a digital imaging means.

The sixth column 1430 of the table includes catalog information. Stores can provide a catalog to the search facilities so as to provide the customer with more options and a variety of its products. The search facilities may determine one or more pages from the catalog (e.g., corresponding to the particular item searched on, or a category to which the item belongs), or the catalog in its entirety (e.g., corresponding to the store). The catalog image may include a link to additional information. The user can select a catalog image from column 1430. In response, another document (e.g., Webpage) with catalog content may be provided to the user.

Also, note that the Webpage display depicted in FIG. 14 includes directional buttons 1435 and 1440 for navigating back and forth among visited documents for simple browsing.

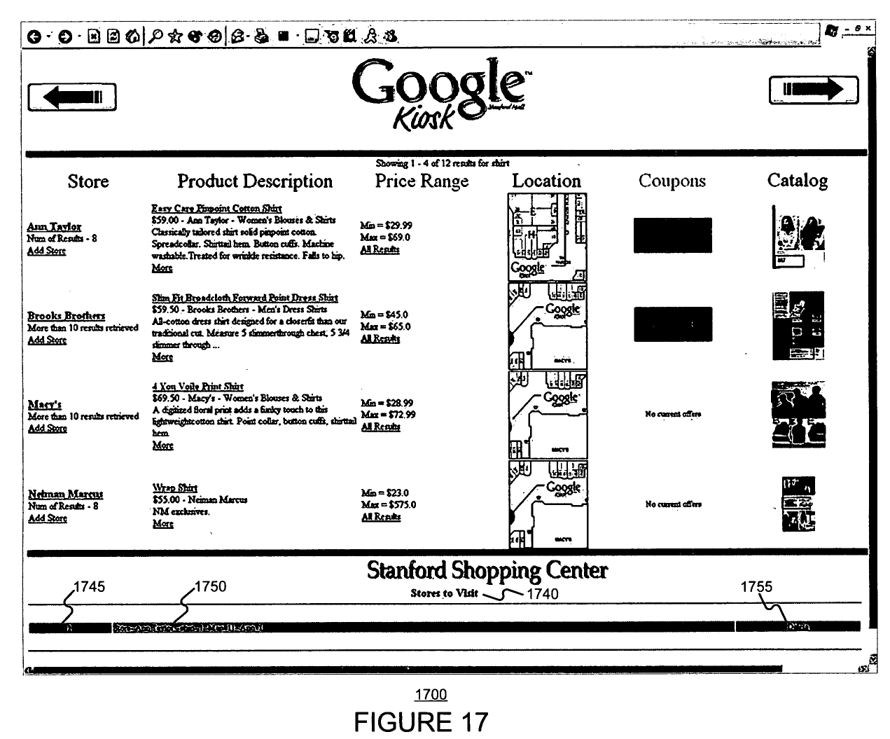

Referring back to column 1405, assume that the user has selected the Ann Taylor store text link. In response, the Webpage depicted by FIG. 14 may be refreshed as depicted in FIG. 17. FIG. 17 is similar to FIG. 14, but has an extra “Stores to Visit” section 1740 on the bottom of the page where a list including one or more entries is displayed. Each entry may include the sequence number of the selection 1745 of the stores selected, and the store name, search query, map number, and coupon number 1750. Selectable text tool 1755 provides a delete option such that the user can delete the store from the “Stores to Visit” list by selecting the “Delete” text.

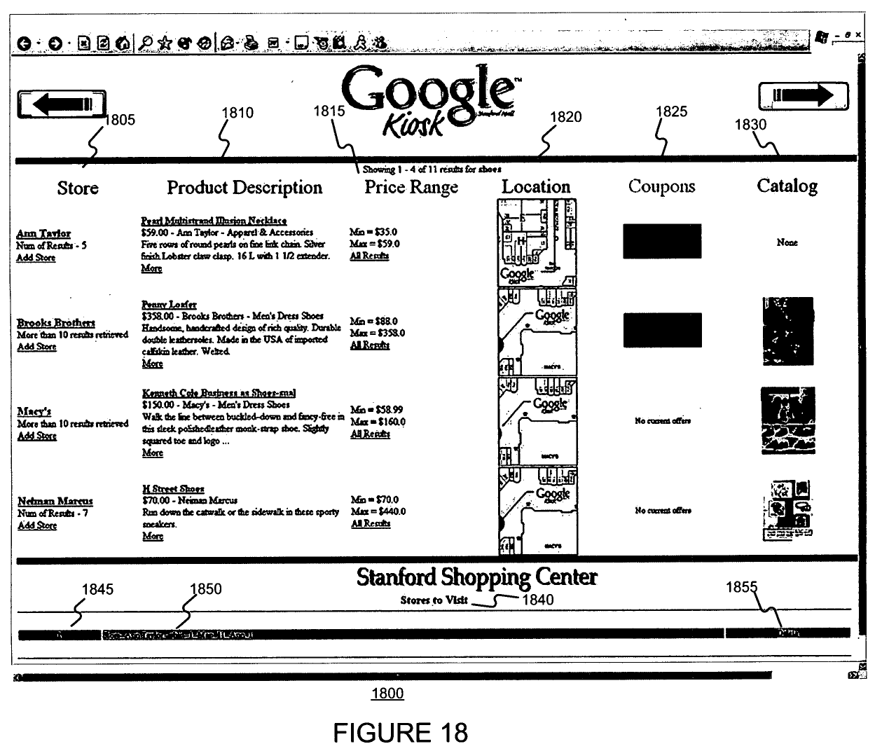

Now assume the user wishes to purchase shoes from the same mall. The user may return to the document screen 1300 depicted in FIG. 13, enter the word “shoes” in box 1310 and select the “locate in mall” button 1330 to initiate the new search. In essence the same process described above with respect to searching for a shirt can be repeated for different items. FIG. 18 is an exemplary screen 1800 (e.g., of a document or page) including search results provided in response to the search query “shoes” in the Stanford Shopping Center. The information provided in columns 1805, 1810, 1815, 1820, 1825 and 1830 is of a similar nature to that provided in columns 1405, 1410, 1415, 1420, 1425, and 1430, respectively. Thus, a description of these columns is not provided. Note that the store to visit section 1840 on the bottom of the Webpage still depicts the Ann Taylor store for purchasing a shirt.

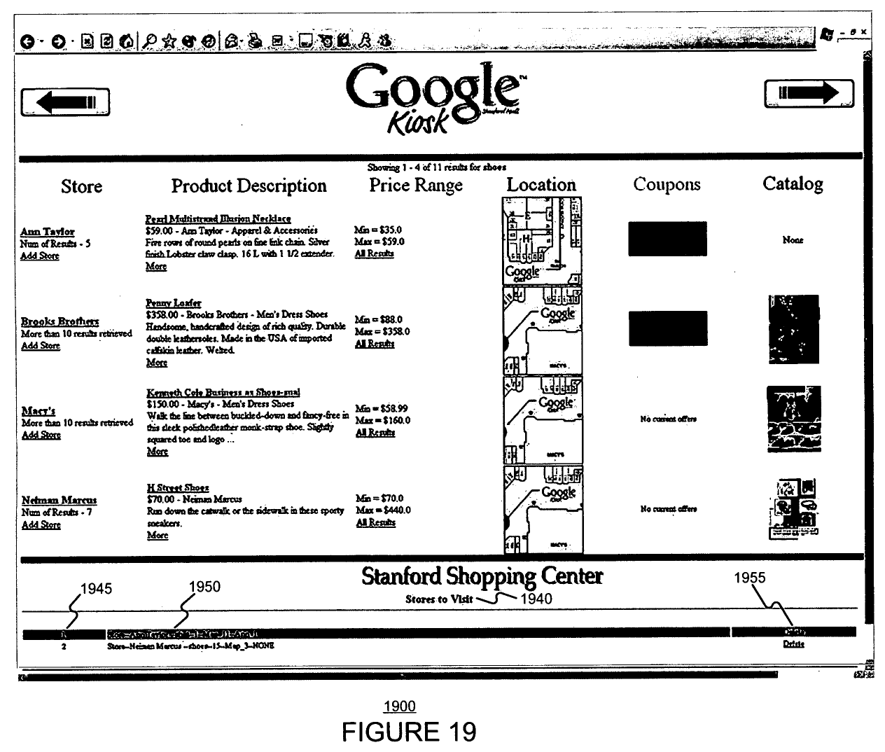

After the user examines all the information, assume that he or she decides to select Neiman Marcus in column 1805 as the store to shop for shoes. As shown in the screen 1900 (e.g., of a document or page) of FIG. 19, the Webpage is refreshed and now includes Neiman Marcus in the “Stores to Visit” section 1940. Column 1945 depicts the stores to visit in sequence, and column 1950 now includes the Neiman Marcus store name along with the search query word “shoes”, map number, and no coupon present indication. Column 1955 provides the option to delete any store from the list the user wishes.

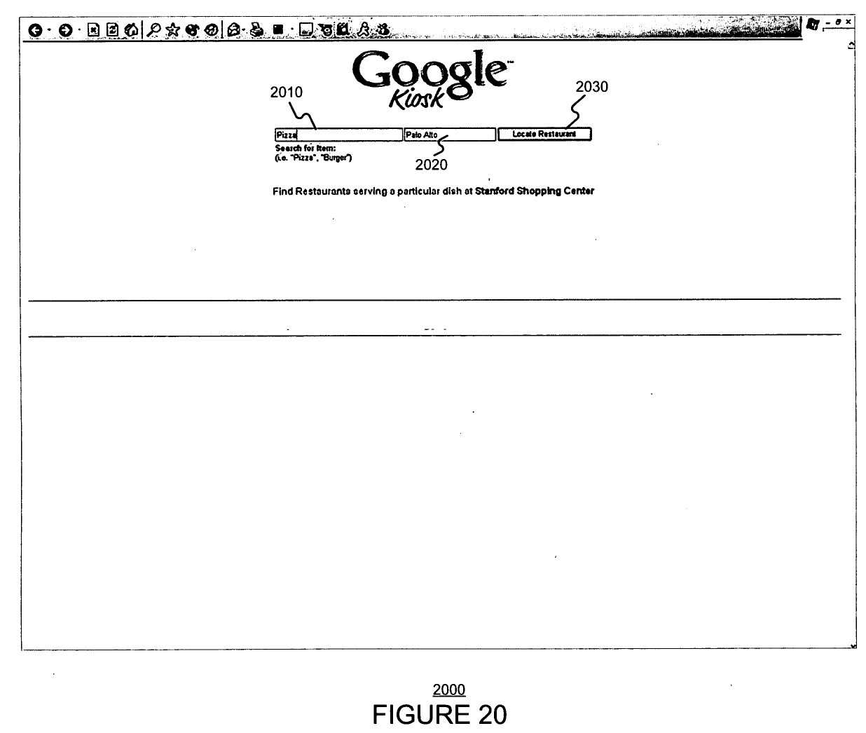

Now suppose the user wishes to go for lunch after shopping. Referring back to FIG. 12, the user may return to the screen 1200 that welcomes the user in the shopping mall and offers the option of searching for food 1205 or searching for stuff 1210. Assume that the user selects “search for food” selectable and executable image 1205. A new screen 2000 of a new Webpage is depicted by FIG. 20. This screen 2000 includes a query box 2010, a box 2020 to filter results using location, and a button 2030 to initiate a search. As can be appreciated, the screen 2000 depicted in FIG. 20 is similar to that 1300 depicted in FIG. 13. In this example the user has entered “pizza” in the text box 2010 and has entered or selected “Palo Alto” as the location of interest. The user may then select the “locate restaurant” button 2030.

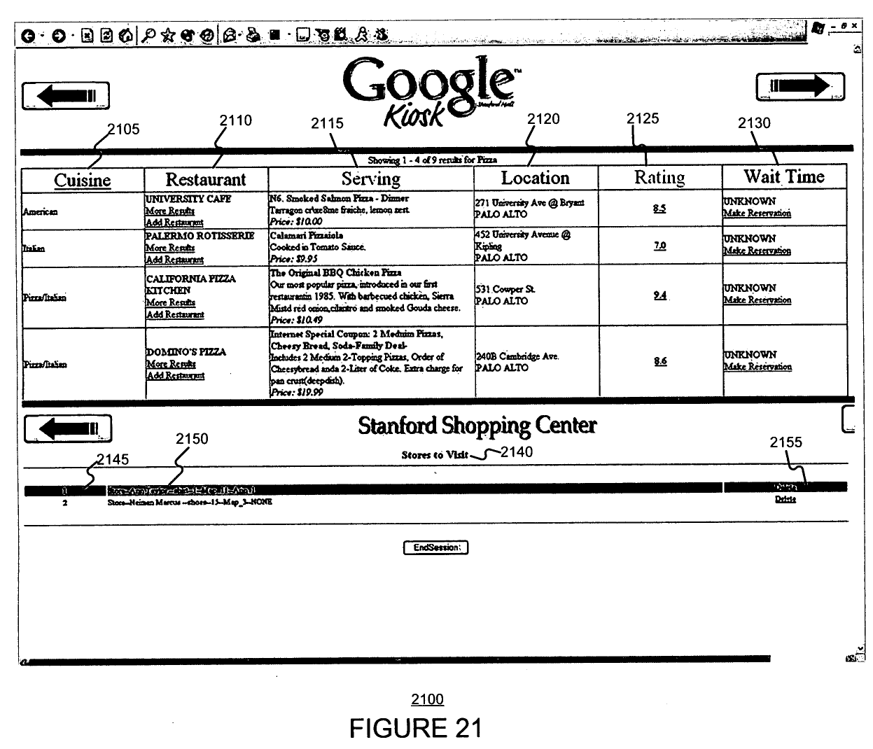

FIG. 21 is an exemplary display 2100 (e.g., of a document or page) including a search results table. The table includes a number of search results corresponding to a number of rows in the table. Each of the search results may include one or more of a cuisine type (e.g., American, Chinese, Hamburgers, Indian, Italian, etc.) 2105, restaurant information 2110, menu information 2115, location information 2120, rating information 2125, and wait time information 2130. Of course, the present invention is not limited to these specific categories; other listed information might be displayed instead of, or in addition to those items shown.

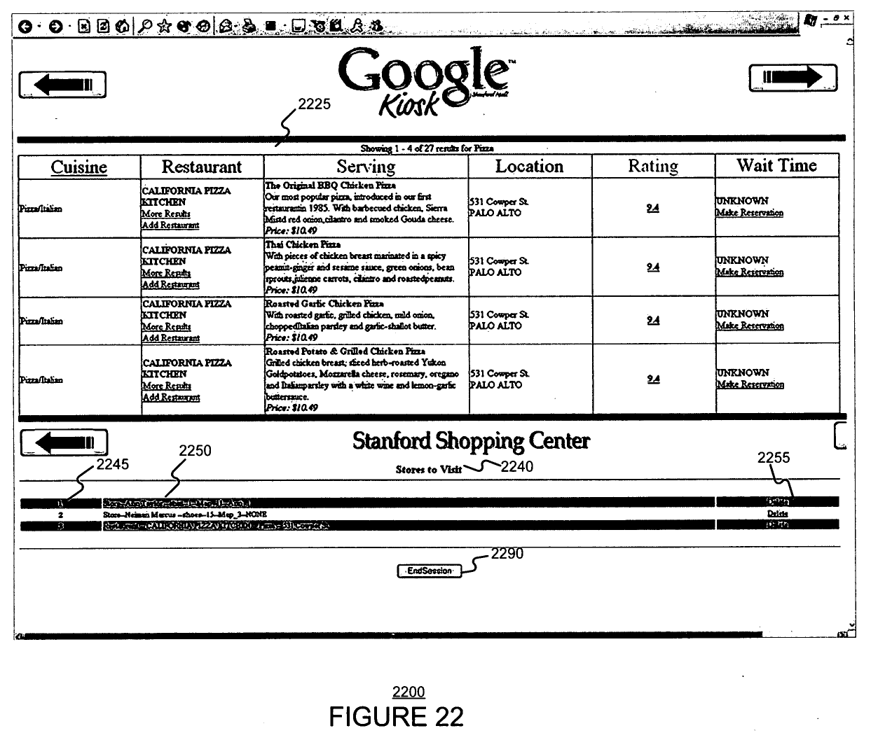

Referring back to column 2110, the restaurant information may include the restaurant names. In this example, each restaurant may have two selectable and executable text links—a “More Results” link and the “Add Restaurant” link. The “More Results” link may be selected by the user to provide more menu items from the restaurant. The “Add Restaurant” link may be selected by the user to add the restaurant into the “Stores to Visit” section 2140, as will be described below with reference to FIG. 22.

Referring back to column 2115 the menu information may include servings offered by the restaurants. In the exemplary embodiment illustrated in FIG. 21, there is one menu item per search result. The menu item may be selected based on a score. The score may be a function of one or more of similarity to the search query, popularity of the menu item, etc. Notice that the servings listed are related to pizza and are generally popular. Each menu item in “Serving” column 2115 may include a name of the dish, a brief description, and the price of the item.

Referring back to column 2120, location information may include the addresses of the restaurants. Although not shown in this example, a distance to the restaurant may be shown as well.

Referring back to column 2125 ratings information may include a rating, for example on the scale of 1 to 10 (or some other rating scale) of the restaurant. Ratings may be customer ratings, ratings by independent food critics, or some combination. Although not shown, ratings may be broken down by food, service, decor, and other features of the restaurant. Further, although the restaurant may be rated overall, if a particular menu item is displayed, a rating for the menu items may be provided instead, or in addition.

Referring back to column 2130, wait time information may include the waiting time (e.g., to be seated, or to pick up a takeout order) of the restaurant, and a selectable and executable text link to permit the user can make reservation. Some embodiments consistent with the present invention may allow the user to place an order for pickup. At least some embodiments consistent with the present invention may allow the user to reserve a table and pre-order their food.

Referring, once again, back to column 2110, assume that the user selects the “Add Restaurant” text in the California Pizza Kitchen restaurant entry. Referring to the display 2100 (e.g., of document or page) of FIG. 22, notice that the California Pizza Kitchen restaurant has been be added to the “Stores to Visit” section 2240. The restaurant is the third in order sequence 2245. Column 2250 depicts all the previously selected stores along with the restaurant. The third entry includes the restaurant name, the search query “pizza,” and the address of the restaurant. Column 2255 provides selectable and executable text to delete any store or restaurant from the list.

Still referring to FIG. 22, notice that the table in the display includes additional menu items in the serving column. The menu items displayed in the table may be selected based on a score. The score may be a function of one or more of similarity to the search query, popularity of the menu item, etc. In this example, notice that the display includes different types of pizza served by the California Pizza Kitchen (as well as descriptions and prices).

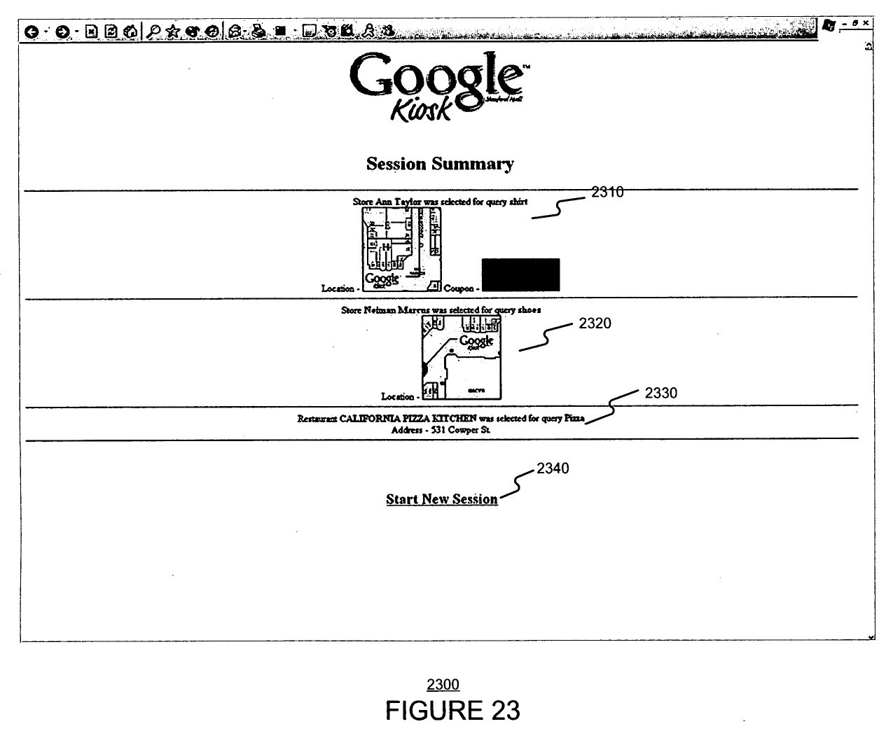

Assume that the user has finished searching for information (e.g., because they have accomplished searching for items they intend to purchase or inspect during their “shopping session”). Still referring to FIG. 22, the user may select the selectable and executable “end session” button 2290. (Notice that an “end session” button was also provided in the displays of 1400 and 2100 of FIGS. 14 and 21 (and may be provided in other documents, but displayed off-screen in some Figures), respectively.) If the user selects the “end session” button 2290, a session summary document (e.g., page) may be loaded. An example of a display 2300 of such a session summary document (e.g., page) is depicted in FIG. 23.

The exemplary display screen 2300 (e.g., of a document or page) of FIG. 23 includes, in order of selection, the selected store or restaurant names along with maps, addresses, coupons, and search queries. The first session summary entry 2310 includes the Ann Taylor store name, the search query term “shirt”, the interactive map, and the coupon. In at least some embodiments consistent with the present invention, the user may select the interactive map or the coupon to display them in more detail, and/or to print them so that they can be used. The second session summary entry 2320 includes the Neiman Marcus store name, the search query “shoes” and the interactive map. The third session summary entry 2330 includes the “California Pizza Kitchen” restaurant name, the search query “pizza” and the address of the restaurant. In this example, no map was provided because the restaurant is outside of the mall. Naturally, a street map may be provided. The session summary provides the user with a useful summary which may include all of the pertinent information needed for a productive and enjoyable excursion of shopping and dinning. Although not shown, a “back” navigation button may be used to allow the user to continue searching for additional items, or to revise their “Stores to Visit” list. Additionally, if the user wants to plan a new shopping session, they may select a “start new session” button 2340.

Although, the foregoing examples mainly concerned products, the present invention may be used in the context services and the establishments that offer such services.

### § 4.4 CONCLUSIONS

As can be appreciated from the foregoing, some embodiments consistent with the present invention may be used to help establishments to determine whether to provide promotional offers (e.g., coupons) at all, and/or the terms of such promotional offers (amount of discount). This determination may be a function of one or more of a search query, search results, user gender (perhaps inferred by captured image), store membership (e.g., Safeway club card), other user information, absolute (e.g., GPS) or relative location information, distance of the establishment from device (e.g., Kiosk), distance of competing establishment from Kiosk, store inventory, service capacity or excess capacity, whether goods are perishable and if so, their remaining shelf life (e.g., donuts will be stale if they aren't sold by end of day), user/product/service relationship algorithms (e.g., some similar to you liked A and B, you liked A, therefore you may also like B), etc.

Such dynamic promotional offers may help stores to increase impulse purchases, since the user has expressed an interest in an item and they are already at a location (e.g., a shopping mall) from which they can make a purchase relatively easily.

Keyword targeting, concept targeting, and/or collaborative filtering, etc., may be used to help determine relevant, useful promotional offers.

What is claimed is:

1. A computer-implemented method comprising:
a) accepting information concerning at least one of (A) a search query entered, at a client device, by a user, (B) an item or establishment which is the subject of a search result selected by a user using a client device, (C) one or more items or establishments which are elements of a shopping session summary provided to a user via a client device;
b) determining a promotional offer to serve using at least the accepted search query information; and
c) determining terms of the promotional offer using at least one of (A) a location of the client device, (B) a distance from the client device to an establishment associated with the promotional offer, and (C) a distance from the client device to an establishment competing with the establishment associated with the promotional offer.

2. The computer-implemented method of claim 1 wherein the act of determining terms of the promotional offer further uses a gender of the user.

3. The computer-implemented method of claim 2 wherein the gender of the user is provided to the device by the user.

4. The computer-implemented method of claim 2 wherein the device includes imaging means, and wherein the gender of the user is estimated based on one or more images captured by the imaging means.

5. The computer-implemented method of claim 1 wherein the act of determining terms of a promotional offer further uses acts of the user.

6. The computer-implemented method of claim 5 wherein the acts of the user include (A) the user requesting additional information about a search result item, (B) the user selecting a search result item, (C) the user adding the search result item to a shopping session list, and (D) the user request of a shopping session summary.

7. The computer-implemented method of claim 1 wherein the client device is a fixed terminal having a predetermined location.

8. The computer-implemented method of claim 1 wherein the client device is a mobile device including means for determining a location of the mobile device.

9. A computer-implemented method comprising:
a) accepting information concerning at least one of (A) a search query entered, at a client device, by a user, (B) an item or establishment which is the subject of a search result selected by a user using a client device, (C) one or more items or establishments which are elements of a shopping session summary provided to a user via a client device;
b) determining a promotional offer, concerning goods or services, to serve using at least the accepted search query information; and
c) determining terms of the promotional offer using at least one of (A) an inventory, at an establishment associated with the promotional offer, of the goods which the promotional offer concerns, (B) a capacity, at an establishment associated with the promotional offer, to provide the services which the promotional offer concerns, (C) a level of excess capacity, at an establishment associated with the promotional offer, to provide the services which the promotional offer concerns, (D) a perishability of goods which the promotional offer concerns, and (E) a remaining shelf-life of goods which the promotional offer concerns.

10. The computer-implemented method of claim 9 wherein the act of determining terms of the promotional offer further uses a gender of the user.

11. The computer-implemented method of claim 10 wherein the gender of the user is provided to the device by the user.

12. The computer-implemented method of claim 10 wherein the device includes imaging means, and wherein the gender of the user is estimated based on one or more images captured by the imaging means.

13. The computer-implemented method of claim 9 wherein the act of determining terms of a promotional offer further uses acts of the user.

14. The computer-implemented method of claim 13 wherein the acts of the user include (A) the user requesting additional information about a search result item, (B) the user selecting a search result item, (C) the user adding the search result item to a shopping session list, and (D) the user request of a shopping session summary.

15. The computer-implemented method of claim 9 wherein the client device is a fixed terminal having a predetermined location.

16. The computer-implemented method of claim 9 wherein the client device is a mobile device including means for determining a location of the mobile device.

17. Apparatus comprising:
(a) means for accepting information concerning at least one of (A) a search query entered, at a client device, by a user, (B) an item or establishment which is the subject of a search result selected by a user using a client device, (C) one or more items or establishments which are elements of a shopping session summary provided to a user via a client device;
(b) means for determining a promotional offer to serve using at least the accepted search query information; and
(c) means for determining terms of the promotional offer using at least one of (A) a location of the client device, (B) a distance from the client device to an establishment associated with the promotional offer, and (C) a distance from the client device to an establishment competing with the establishment associated with the promotional offer, (D) an inventory, at an establishment associated with the promotional offer, of the goods which the promotional offer concerns, (E) a capacity, at an establishment associated with the promotional offer, to provide the services which the promotional offer concerns, (F) a level of excess capacity, at an establishment associated with the promotional offer, to provide the services which the promotional offer concerns, (G) a perishability of goods which the promotional offer concerns, and (H) a remaining shelf-life of goods which the promotional offer concerns.
